(19) United States
(12) Patent Application Publication
(10) Pub. No.: US 2009/0150067 A1
(43) Pub. Date: Jun. 11, 2009

(54) Navigation and Itinerary Management System

(76) Inventor: Dorothy Veronica Lindman, Fort Worth, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 11/951,843

(22) Filed: Dec. 6, 2007

(51) Int. Cl. G01C 21/00

(52) U.S. Cl. 701/204

(57) ABSTRACT

A navigation device comprises an itinerary preparation and management system. The device includes a memory for storing itinerary data including data representative of a destination and a time constraint, such as a deadline, earliest time, or range of times during which the user wants to arrive at the destination. The navigation device also includes a display for displaying the itinerary, a position detection system for detecting positional information associated with the navigation device, and a processor programmable to correlate the positional information with the itinerary data and detect an inability to satisfy the time constraint. The navigation device has access to alternative destinations and is able to determine whether one of the alternative destinations will satisfy the time constraint. If so, the navigation device provides the user with an opportunity to replace the destination with the alternative destination.

### TECHNICAL FIELD

The present disclosure relates to a positional information determining apparatus, and is preferably applied to a global positioning system (GPS) navigation system that receives satellite waves coming from a plurality of GPS satellites, for example.

### BACKGROUND

Navigation devices have been widely available for a number of years. Navigation devices typically include mapping software and a positional information determining subsystem, such as a global positioning satellite receiver capable of receiving satellite signals and using the received information to determine the position of the navigation device. Navigation systems can typically display a map, as well as an indication of the current location on the map. Navigation systems can typically calculate a route from the current location to a destination provided by the user and provide an indication of the route on the displayed map.

Some navigation devices are stand-alone, hand-held devices. Other navigation devices are integral with larger systems, a common example being automobiles having onboard navigation systems. Some devices, such as cellular telephones and handheld computers include navigation functionality, and can also be considered navigation devices.

### BRIEF DESCRIPTION OF THE DRAWINGS

Embodiments are illustrated by way of example in the accompanying figures, in which like reference numbers indicate similar parts, and in which:

FIG. 1 shows a block diagram of an embodiment of a navigation device that includes itinerary preparation and management functionality;

FIG. 2 shows a table as an example of data input by a user for use by the navigation device in preparing an itinerary;

FIG. 3 shows an example of an itinerary prepared by the navigation system based on the data shown in FIG. 2;

FIG. 4 shows an example of an updated version of the itinerary shown in FIG. 3 due to an unexpected delay that fails to conform to user-provided time constraints;

FIG. 5 shows an example of an updated version of the itinerary shown in FIG. 4 that includes an alternative destination and conforms to user-provided time constraints;

FIG. 6 shows a flowchart illustrating a method of revising the itinerary to include an alternative destination;

FIG. 7 shows a flowchart illustrating a method of selecting an alternative destination;

FIG. 8 shows a flowchart illustrating an alternative method of selecting an alternative destination; and

FIG. 9 shows a flowchart illustrating another alternative method of selecting an alternative destination.

### DETAILED DESCRIPTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

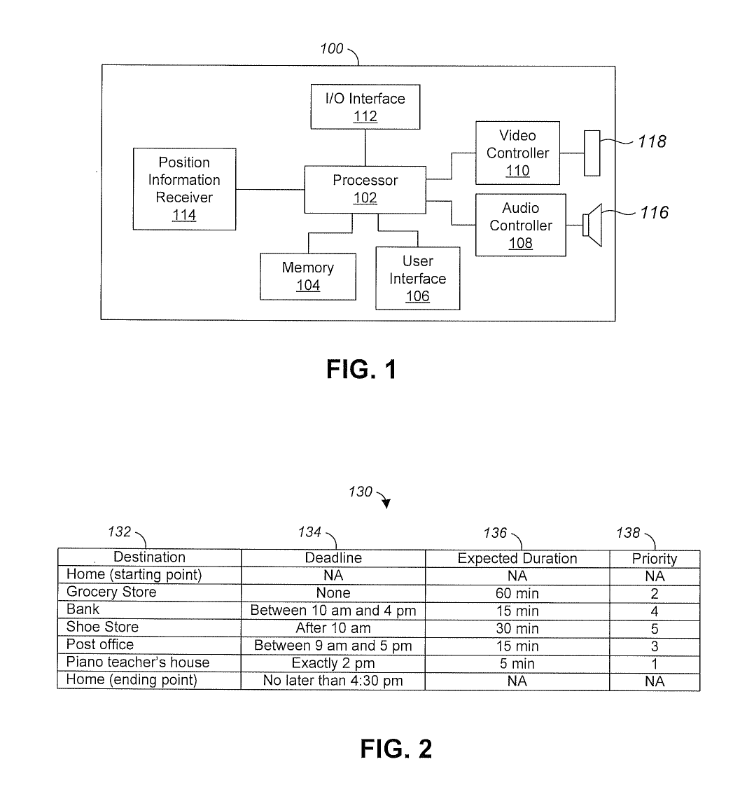

Referring initially to FIG. 1, which shows a block diagram of an embodiment of a navigation device 100 that includes itinerary preparation and management functionality. Embodiments of the navigation device 100 can include dedicated navigation devices, cellular telephones, handheld computers, and onboard navigation systems integral to vehicles such as automobiles, boats, or airplanes. The navigation device 100 includes a processor 102 for controlling overall functioning of the navigation device 100. The processor 102 is in communication with one or more electronic and/or computer memories, generally shown as memory 104, a user interface 106, an audio controller 108, a video controller 110, an input/output (I/O) interface 112, and a position information receiver 114.

The memory 104 can include, for example, static random access memory (SRAM), dynamic random access memory (DRAM), magnetic random access memory (MRAM), Flash memory, optical hard disk, digital video disk (DVD), and/or compact disck (CD). The memory 104 can include memory integrated with the processor 102. The memory 104 can include a database or other suitable data structure(s) that includes map data and data representative of points of interest (POIs), business and residential listings, including phone numbers and addresses, and various software instructions for controlling functions of the navigation device, including determining routes from one geographic location to another according to known methods and for performing processes described herein.

The user interface 106 can include one or more of any known means by which a user can interact with computer or other electronic device. Common examples can include buttons, knobs, keypads, cursor-control devices, touch screens, and voice-recognition systems. In some embodiments, one or more components of the user interface 106 can be remote from the navigation device 100. For example, where the navigation device 100 is integral or otherwise located in an automobile, components of the user interface 106 can be located on the steering wheel of the automobile.

The audio controller 108 can be any known controller for driving one or more speakers 116 based on data received from the processor 102 according to known methods. In some embodiments, one or more components of the audio controller 108 and/or one or more speakers 116 can be remote from the navigation device 100. For example, where the navigation device 100 is integral or otherwise located in an automobile, components of the audio controller 108 can be located in the automobile's audio system, and/or one or more of the speakers 116 can be one or more speakers integral to the automobile.

The video controller 110 can be any known controller for driving one or more video displays 118 based on data received from the processor 102 according to known methods. In some embodiments, one or more components of the video controller 110 and/or one or more displays 118 can be remote from the navigation device 100. For example, where the navigation device 100 is integral or otherwise located in an automobile, components of the video controller 110 and/or one or more video displays can be integral to the automobile.

The I/O interface 112 can be any known I/O interface for allowing the navigation device 100 to communicate wired and/or wirelessly with other electronic devices and/or memories. For example, the I/O interface 112 can include, for example, a serial data port such as a universal serial bus (USB) port, a memory-card slot such as a secure data (SD) slot, audio and/or video input and/or output jacks, a Bluetooth receiver and/or transmitter, a receiver/transmitter for communicating via a commercial mobile radio service (CMRS) such as a time division multiple access (TDMA), Global System for Mobile communications (GSM), or Code division multiple access (CDMA) wireless network, and/or means for communicating via a broadband Internet network via an Ethernet or WiFi comiection.

The position information receiver 114 can include any known means for determining a geographical location of the navigation device 100. For example, the position information receiver 114 can include a global positioning satellite (GPS) receiver and antenna (not shown). In some embodiments, one or more components of the position information receiver 114 can be remote from the navigation device 100. For example, where the navigation device 100 is integral or otherwise located in an automobile, components of the position information receiver 114 can be integral to the automobile or otherwise remotely located from the navigation device 100. For example, in embodiments where the position information receiver 114 includes a GPS receiver and antenna, the antenna can be located on an external surface of the automobile.

Referring next to FIG. 2, which shows a table 130 as an example of data input by a user for use by the navigation device 100 in preparing an itinerary. A user can input various pieces of information to the navigation device 100, preferably including at least information shown in the table 130. Some or all of the information in table 130 can be input via the user interface 106. Alternatively, some or all of the information in table 130 can be input on a separate device, such as a personal computer (not shown) and transferred to the navigation device 100 via the I/O interface 112.

The information in table 130 includes destinations 132. The information associated with each of the destinations 132 input by the user can include a street address or other information that the navigation device 100 can use to determine a geographic location of each destination 132. As a starting and/or ending point, for example, the user can instruct the navigation device 100 to detect the current location of the navigation device using the position information receiver 114 and use the detected current location as the starting and/or ending point destination. In some embodiments, the memory 104 can have previously-entered geographical location information regarding one or more of the destinations 132 that the user can select or otherwise reference, for example by entering a nickname or contact name associated with a location stored in the memory 104.

The information in table 130 also includes a deadline 134 associated with each destination 132. The deadline 134 can be an earliest time that the user would want to arrive at the associated destination 132, a latest time that the user would want to arrive at the associated destination 132, an exact time that the user wants to arrive at the associated destination 132, or a range of times between which the user wants to arrive at the associated destination 132. This information can be entered by the user, for example based on when a user needs to be at the associated destination 132 or when a user knows that the associated destination 132 is available, for example hours of operation where a destination is a business. In some embodiments, the navigation device 100 can suggest deadline information based on appointment information or calendar information stored in the memory 104 or retrieved via the I/O interface 112 from an external electronic device having an electronic calendar or the like. In some embodiments, the navigation device 100 can suggest deadline information based on information regarding a destination's hours of operation stored in the memory 104 or retrieved via the I/O interface 112 from an external electronic device, including a remote business listing that includes data regarding hours of operation of an associated destination 132.

The information in table 130 also includes an expected duration 136 and priority 138 associated with each destination 132. The expected duration 136 can be provided by the user and is representative of an amount of time that the user expects to spend at the associated destination 132. In some embodiments, the navigation device 100 can suggest duration information based on appointment information or calendar information stored in the memory 104 or retrieved via the I/O interface 112 from an external electronic device having an electronic calendar or the like. The priority 138 is optional information that can be provided by the user and used by the navigation device 100 for resolving situations where all destinations 132 cannot fit into the itinerary.

Referring next to FIG. 3, which shows an example of an itinerary 140 prepared by the navigation system 100 based on the data shown in FIG. 2. The itinerary 140 can be prepared by the processor 102 according to itinerary-preparation software instructions stored in the memory 104. Software instructions for preparing the itinerary 140 can be based on known combinatorial optimization algorithms for finding optimal routes for visiting multiple destinations. The itinerary 140 includes a list of itinerary destinations 142, which includes all of the destinations 132 or a subset of the destinations 132 where it is not possible to prepare an itinerary 140 that includes all of the destinations 132. The itinerary 140 also includes an estimated arrival time 144, duration 146, estimated departure time 148, and estimated time to next destination 149 for each of the itinerary destinations 142. Each duration 146 corresponds with an expected duration 136 in the table 130. The estimated arrival time 144, estimated departure time 148, and estimated time to next destination 149 are determined by the processor 102 according to the itinerary-preparation software instructions stored in the memory 104.

The navigation device 100 tracks the progress of the user as the user progresses through the itinerary 140. The navigation device 100 tracks the geographic location of the user based on information received via the position information receiver 114. The navigation device 100 can also include an internal clock or receive information about the time via the position information receiver 114 or the I/O interface 112. Using time and location information, the navigation device 100 can track the user's progress and detect deviations from the itinerary 140, for example spending more time than the expected duration 146 at an associated destination 142, or taking more than an estimated time to next destination 149 to get to a next destination 142. There are many things that can disrupt an itinerary 140, and wherever the navigation device 100 detects a deviation from the itinerary 140, the navigation device 100 updates the itinerary 140 and determines whether the itinerary is still possible to complete without replacing or eliminating one or more of the destinations 144. In some embodiments, the navigation device 100 can anticipate delays that will require revision of the itinerary 140. For example, in some embodiments the navigation system 100 can be in contact with traffic reports via the I/O interface 112. When the navigation system 100 determines unexpected traffic delays will affect the itinerary, the navigation system 100 can revise the itinerary 140 and/or re-route the user around the traffic congestion.

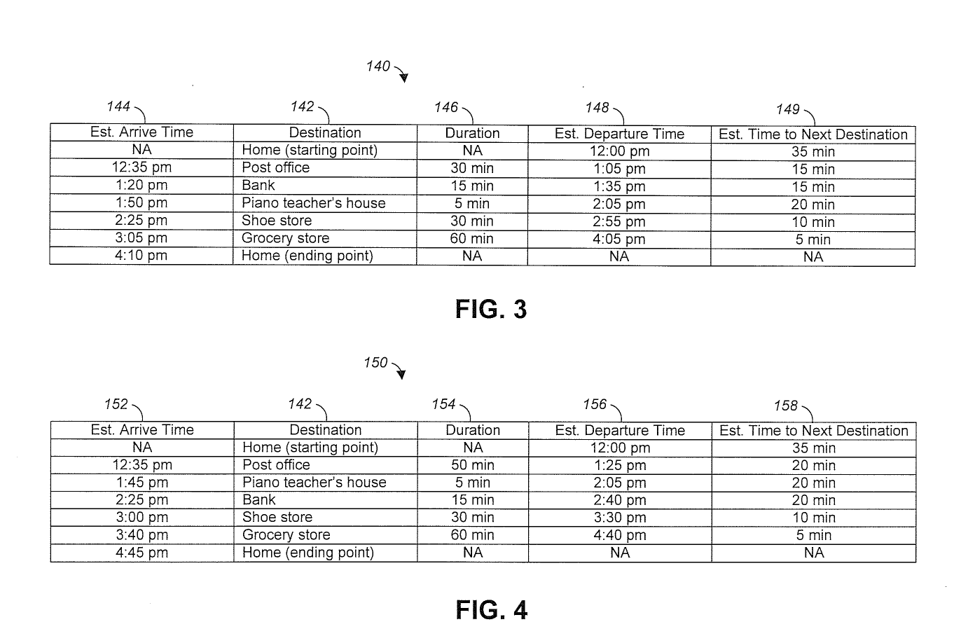

Referring next to FIG. 4, which shows an example of an updated itinerary 150, which is an updated version of the itinerary 140 shown in FIG. 3 due to an unexpected delay that fails to conform to user-provided time constraints. The updated itinerary 150 includes the same list of destinations 142. The updated itinerary 150 includes estimated arrival times 152, durations 154, estimated departure times 156, and estimated times to next destination 158 that are revised according to detected and projected changes. In this example, the duration at the post office was 50 minutes rather than the 30 minutes originally planned, so it is now not possible to arrive at the ending point by the prescribed deadline of 4:30.

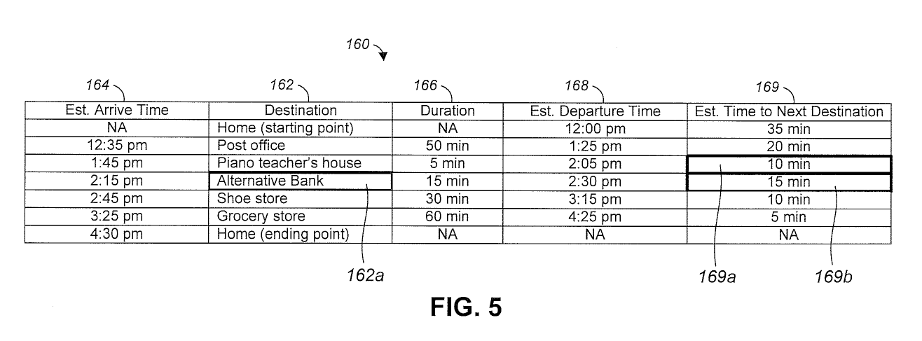

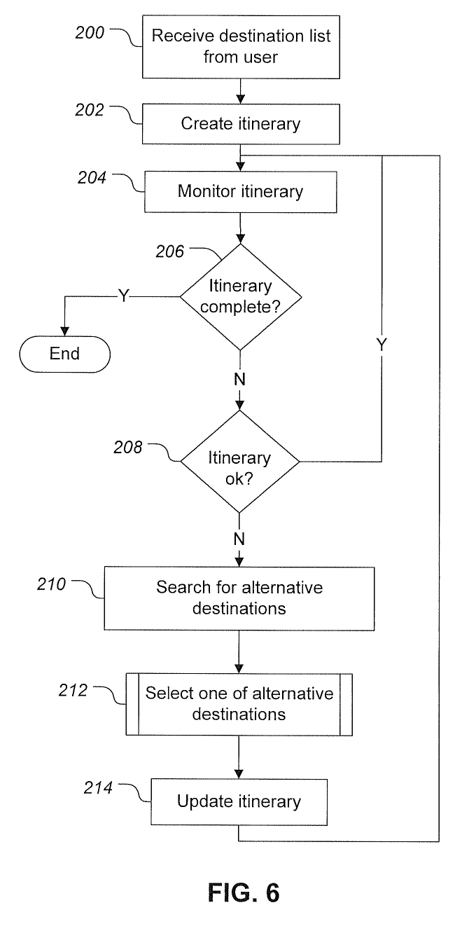

Referring next to FIG. 5, which shows an example of an revised itinerary 160, which is a revised version of the itinerary 150 shown in FIG. 4 that includes an alternative destination and conforms to user-provided time constraints. The revised itinerary 160 includes a list of destinations 162 that has been revised according to one or more methods described below in connection with FIGS. 6-9. The list of destinations 162 now includes an alternative bank 162a. The revised itinerary 160 also includes an estimated arrival time 164, duration 166, estimated departure time 168, and estimated time to next destination 169 for each destination 162. The estimated times 169a and 169b are revised to reflect revised travel times associated with the alternative bank 162a. As shown in FIG. 5, this change allows the user to now have a revised itinerary 160 that allows for arrival at the ending point by the prescribed deadline.

Referring next to FIG. 6, which shows a flowchart illustrating a method of revising the itinerary to include an alternative destination. At 200, the navigation device 100 receives a destination list and other information from the user, for example as described above in connection with FIG. 2. Next, at 202 the navigation device 100 prepares the itinerary 140 as described above in connection with FIG. 3. Next, at 204 the navigation device 100 monitors the itinerary 140 as time passes and the user progresses through the destinations 132. At 206, if the user arrives at the end of the itinerary 140, the process ends. Otherwise, at 208, the navigation device 100 determines whether the itinerary 140 needs to be updated or revised, for example due to durations or travel times that are longer than planned for in the itinerary 140 (for example, as discussed above in connection with FIG. 4). If the itinerary 140 does not need revising, then the process returns to 204 for continued monitoring.

If the itinerary 140 needs to be revised, for example because of a deviation from the itinerary as described above in connection with the revised itinerary shown in FIG. 4, then the process continues to 210 where the navigation device 100 searches for alternative destinations. In a preferred embodiment, the navigation device 100 searches for an alternative destination for the lowest-priority destination that has not yet been visited. More specifically, the processor 102 identifies the lowest priority destination, and searches the memory 104 and/or remote data available via the I/O interface 112 for an alternative to the low-priority destination that has a geographic location near at least one of the other remaining destinations on the itinerary or is near one of the routes between remaining destinations and allows for a revised itinerary to be prepared that satisfies criteria such as deadlines 134 provided by the user. If no alternative location is found for the destination having the lowest priority, the navigation device 100 continues to look for alternative destinations for other destinations 132 in the itinerary 140 working from the lowest priority to the highest priority destination 132 until at least one alternative destination is found. Note that some destinations (such as the piano teacher's house listed in FIGS. 2-5) can be flagged by the user as destinations for which no alternative should be sought by the navigation system. The process as shown in FIG. 6 assumes at least one alternative destination is found. Note, however, that if no alternative destination is found for any of the destinations 132, then one of the destinations can be eliminated from the itinerary based on priority (for example, the lowest priority destination not yet visited can be eliminated from the itinerary).

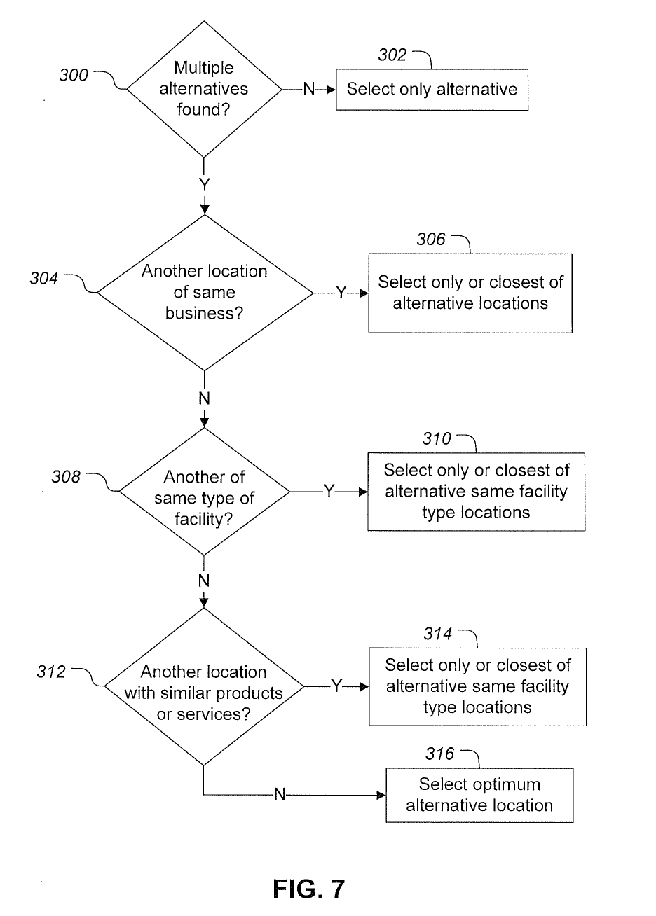

Next, at 212, one of the alternative destinations found at 210 is selected and at 214 the itinerary is updated, for example as described above in connection with FIG. 5. In some embodiments, at 212 the navigation device 100 displays the list of alternative destinations to the user and gives the user an opportunity to select one of the alternative destinations from the list. In other embodiments, at 212 the navigation device 100 automatically selects one of the alternative destinations according to one or more of the embodiments described below in connection with FIGS. 7-9. In such embodiments, the navigation device 100 can optionally provide the user with the option of accepting the automatically-selected alternative destination or manually selecting a different alternative destination or eliminating the destination from the itinerary altogether.

Referring next to FIG. 7, which shows a flowchart illustrating a first example of a method of selecting an alternative destination at 212 in FIG. 6. At 300, if only one alternative destination was found, then at 302 the sole alternative destination is selected. Otherwise, at 304 the navigation device 100 determines whether any of the alternative destinations is a different location of the same business that was designated as the original destination. For example, if the original destination was a branch of a certain bank, at 304 the navigation device 100 determines whether any of the alternative destinations is another branch of the same bank. Other examples can be alternative locations of the same restaurant, same retailer, or same company or franchise. If an alternative destination is found to satisfy the criteria at 304, then at 306 this alternative location is selected. Note that if there are multiple alternative destinations that satisfy the criteria at 304, then at 306 the navigation device 100 selects the alternative destination that allows for the most efficient itinerary.

If no alternative destination is found to satisfy the criteria at 304, then the process continues to 308. At 308 the navigation device 100 determines whether any of the alternative destinations is another of the same type or class as the business that was designated as the original destination. For example, if the original destination was a branch of a certain bank, at 308 the navigation device 100 determines whether any of the alternative destinations is another bank. Other examples can be alternative restaurants serving the same cuisine as the restaurant that was the original destination, alternative retailers that offer the same types of goods and services as the retailer that was the original destination, or an alternative company or franchise that provides the same class or type of goods or services as the company or franchise that was the original destination. If an alternative destination is found to satisfy the criteria at 308, then at 310 this alternative is selected. Note that if there are multiple alternative destinations that satisfy the criteria at 308, then at 310 the navigation device 100 selects the alternative destination that allows for the most efficient itinerary.

If no alternative destination is found to satisfy the criteria at 308, then the process continues to 312. At 312 the navigation device 100 determines whether any of the alternative destinations offers similar products or services despite being a different business and different class of business. For example, if the original destination was a branch of a certain bank, at 312 the navigation device 100 determines whether any of the alternative destinations is a business that has an ATM machine where the user might be able to perform a transaction that would have been performed at the original bank destination. Other examples can include an alternative restaurant that serves a different cuisine but is in the same price range as the restaurant that was the original destination. If an alternative destination is found to satisfy the criteria at 312, then at 314 this alternative is selected. Note that if there are multiple alternative destinations that satisfy the criteria at 312, then at 314 the navigation device 100 selects the alternative destination that allows for the most efficient itinerary.

If no alternative destination is found to satisfy the criteria at 312, then at 316 whatever alternative destination(s) which was found is selected as the alternative destination. For example, if the original destination was a restaurant, but the restaurant that was found fails to satisfy the criteria at 304, 308, or 312, the user might still want the restaurant added to the itinerary so at least there is somewhere to eat along the way. In some embodiments, at 316 the navigation device 100 can provide the user with the option of accepting the alternative or simply eliminating the original destination from the itinerary.

Note that in some embodiments, the process shown in FIG. 7 can be used to prepare a list of alternative destinations for the user, where alternative destinations selected at 306 are listed first, alternative destinations selected at 310 are listed second, alternative destinations selected at 314 are listed third, and any remaining destinations are listed last.

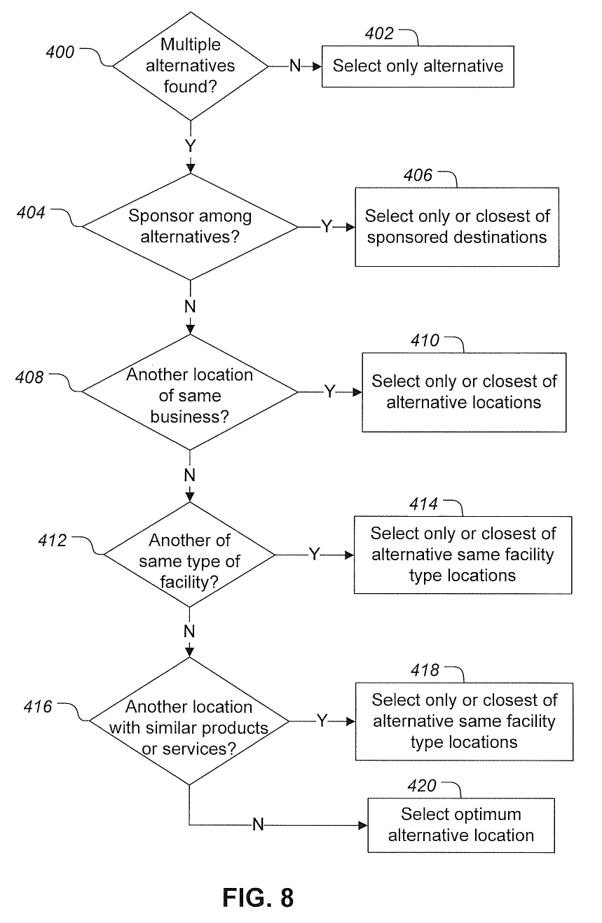

Referring next to FIG. 8, which shows a flowchart illustrating a second example of a method of selecting an alternative destination at 212 in FIG. 6. In this embodiment, prior to the process shown at FIG. 8 one or more businesses such as retailers or restaurants can pay to become a sponsoring business. This allows for a source of income for a company that provides business listings and other such information to the navigation device 100.

At 400, if only one alternative destination was found, then at 402 the sole alternative destination is selected. Otherwise, at 404 the navigation device 100 determines whether any of the alternative destinations is a sponsoring business. For example, if the original destination was a retailer, at 404 the navigation device 100 determines whether any of the alternative destinations is a similar retailer that has paid to be a sponsoring location that gets presented first as an alternative for users looking for alternative locations. If a sponsoring alternative destination is found at 404, then at 406 this alternative location is selected. Note that if there are multiple alternative destinations that satisfy the criteria at 404, then at 406 the navigation device 100 selects the alternative destination that allows for the most efficient itinerary.

If no alternative destination is found to satisfy the criteria at 404, then the process continues to 408. At 408 the navigation device 100 determines whether any of the alternative destinations is a different location of the same business that was designated as the original destination. For example, if the original destination was a branch of a certain bank, at 408 the navigation device 100 determines whether any of the alternative destinations is another branch of the same bank. Other examples can be alternative locations of the same restaurant, same retailer, or same company or franchise. If an alternative destination is found to satisfy the criteria at 408, then at 410 this alternative location is selected. Note that if there are multiple alternative destinations that satisfy the criteria at 408, then at 410 the navigation device 100 selects the alternative destination that allows for the most efficient itinerary.

If no alternative destination is found to satisfy the criteria at 408, then the process continues to 412. At 412 the navigation device 100 determines whether any of the alternative destinations is another of the same type or class as the business that was designated as the original destination. For example, if the original destination was a branch of a certain bank, at 412 the navigation device 100 determines whether any of the alternative destinations is another bank. Other examples can be alternative restaurants serving the same cuisine as the restaurant that was the original destination, alternative retailers that offer the same types of goods and services as the retailer that was the original destination, or an alternative company or franchise that provides the same class or type of goods or services as the company or franchise that was the original destination. If an alternative destination is found to satisfy the criteria at 412, then at 414 this alternative is selected. Note that if there are multiple alternative destinations that satisfy the criteria at 412, then at 414 the navigation device 100 selects the alternative destination that allows for the most efficient itinerary.

If no alternative destination is found to satisfy the criteria at 412, then the process continues to 416. At 416 the navigation device 100 determines whether any of the alternative destinations offers similar products or services despite being a different business and different class of business. For example, if the original destination was a branch of a certain bank, at 416 the navigation device 100 determines whether any of the alternative destinations is a business that has an ATM machine where the user might be able to perform a transaction that would have been performed at the original bank destination. Other examples can include an alternative restaurant that serves a different cuisine but is in the same price range as the restaurant that was the original destination. If an alternative destination is found to satisfy the criteria at 416, then at 418 this alternative is selected. Note that if there are multiple alternative destinations that satisfy the criteria at 416, then at 418 the navigation device 100 selects the alternative destination that allows for the most efficient itinerary.

If no alternative destination is found to satisfy the criteria at 416, then at 420 whatever alternative destination(s) which was found is selected as the alternative destination. For example, if the original destination was a restaurant, but the restaurant that was found fails to satisfy the criteria at 404, 408, 412, or 416 the user might still want the restaurant added to the itinerary so at least there is somewhere to eat along the way. In some embodiments, at 420 the navigation device 100 can provide the user with the option of accepting the alternative or simply eliminating the original destination from the itinerary.

Note that in some embodiments, the process shown in FIG. 8 can be used to prepare a list of alternative destinations for the user, where alternative destinations selected at 406 are listed first, alternative destinations selected at 410 are listed second, alternative destinations selected at 414 are listed third, alternative destinations selected at 418 are listed fourth, and any remaining destinations are listed last.

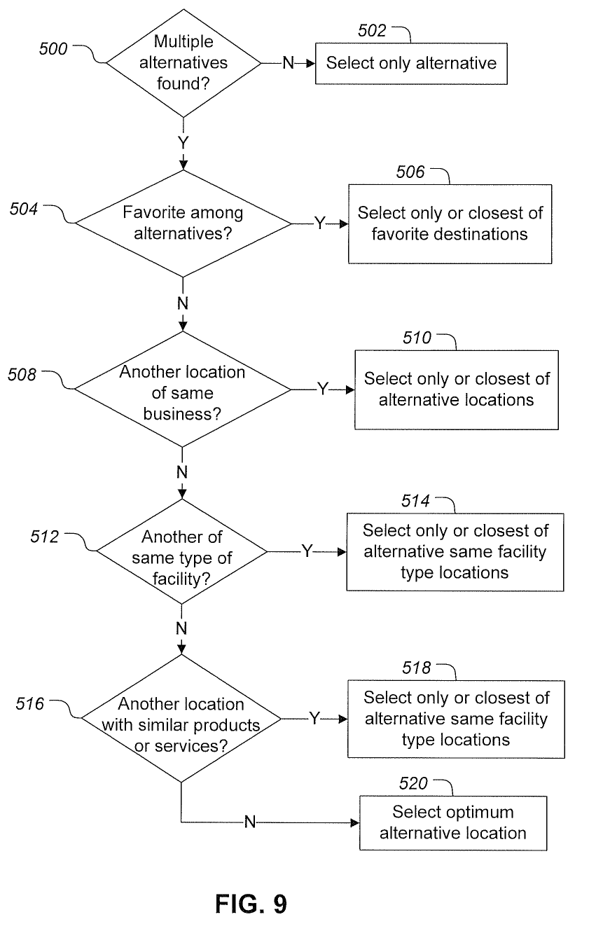

Referring next to FIG. 9, which shows a flowchart illustrating a third example of a method of selecting an alternative destination at 212 in FIG. 6. In this embodiment, prior to the process shown at FIG. 9, the navigation device 100 allows the user to create favorites lists. For example, the user can prepare lists of favorite restaurants, banks, retailers, or other businesses.

At 500, if only one alternative destination was found, then at 502 the sole alternative destination is selected. Otherwise, at 504 the navigation device 100 determines whether any of the alternative destinations is a business on one of the user's favorites lists. For example, if the original destination was an Italian restaurant, at 504 the navigation device 100 determines whether any of the alternative Italian restaurants is listed on the user's list of favorite Italian restaurants. If a favorite alternative destination is found at 504, then at 506 this alternative location is selected. Note that if there are multiple alternative destinations that satisfy the criteria at 504, then at 506 the navigation device 100 selects the alternative destination that allows for the most efficient itinerary.

If no alternative destination is found to satisfy the criteria at 504, then the process continues to 508. At 508 the navigation device 100 determines whether any of the alternative destinations is a different location of the same business that was designated as the original destination. For example, if the original destination was a branch of a certain baiik, at 508 the navigation device 100 determines whether any of the alternative destinations is another branch of the same bank. Other examples can be alternative locations of the same restaurant, same retailer, or same company or franchise. If an alternative destination is found to satisfy the criteria at 508, then at 510 this alternative location is selected. Note that if there are multiple alternative destinations that satisfy the criteria at 508, then at 510 the navigation device 100 selects the alternative destination that allows for the most efficient itinerary.

If no alternative destination is found to satisfy the criteria at 508, then the process continues to 512. At 512 the navigation device 100 determines whether any of the alternative destinations is another of the same type or class as the business that was designated as the original destination. For example, if the original destination was a branch of a certain bank, at 512 the navigation device 100 determines whether any of the alternative destinations is another bank. Other examples can be alternative restaurants serving the same cuisine as the restaurant that was the original destination, alternative retailers that offer the same types of goods and services as the retailer that was the original destination, or an alternative company or franchise that provides the same class or type of goods or services as the company or franchise that was the original destination. If an alternative destination is found to satisfy the criteria at 512, then at 514 this alternative is selected. Note that if there are multiple alternative destinations that satisfy the criteria at 512, then at 514 the navigation device 100 selects the alternative destination that allows for the most efficient itinerary.

If no alternative destination is found to satisfy the criteria at 512, then the process continues to 516. At 516 the navigation device 100 determines whether any of the alternative destinations offers similar products or services despite being a different business aid different class of business. For example, if the original destination was a branch of a certain bank, at 516 the navigation device 100 determines whether any of the alternative destinations is a business that has an ATM machine where the user might be able to perform a transaction that would have been performed at the original bank destination. Other examples can include an alternative restaurant that serves a different cuisine but is in the same price range as the restaurant that was the original destination. If an alternative destination is found to satisfy the criteria at 516, then at 518 this alternative is selected. Note that if there are multiple alternative destinations that satisfy the criteria at 516, then at 518 the navigation device 100 selects the alternative destination that allows for the most efficient itinerary.

If no alternative destination is found to satisfy the criteria at 516, then at 520 whatever alternative destination(s) which was found is selected as the alternative destination. For example, if the original destination was a restaurant, but the restaurant that was found fails to satisfy the criteria at 504, 508, 512, or 516 the user might still want the restaurant added to the itinerary so at least there is somewhere to eat along the way. In some embodiments, at 520 the navigation device 100 can provide the user with the option of accepting the alternative or simply eliminating the original destination from the itinerary.

Note that in some embodiments, the process shown in FIG. 9 can be used to prepare a list of alternative destinations for the user, where alternative destinations selected at 506 are listed first, alternative destinations selected at 510 are listed second, alternative destinations selected at 514 are listed third, alternative destinations selected at 518 are listed fourth, and any remaining destinations are listed last.

In still further embodiments, any combination of any of the criteria shown and described in connection with FIGS. 7-9 can be implemented in any order for selecting an alternative destination or creating an ordered list of alternative destinations from which the user can select an alternative destination for the revised itinerary. In still further embodiments, additional criteria in combination with none or any combination of any of the criteria shown and described in connection with FIGS. 7-9 can be implemented in any order for selecting an alternative destination or creating an ordered list of alternative destinations from which the user can select an alternative destination for the revised itinerary. In still further embodiments, the navigation device 100 can be configured to allow the user to select criteria, create criteria, and/or set the order in which the criteria is applied for selecting an alternative destination or creating an ordered list of alternative destinations from which the user can select an alternative destination for the revised itinerary.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

What is claimed is:

1. A navigation device comprising an itinerary preparing system for preparing and maintaining an itinerary, the system comprising:
memory for storing itinerary data associated with the itinerary, the itinerary data including data representative of a destination and a time constraint associated with the destination;
a display for displaying the itinerary;
a position detection system for detecting positional information associated with the navigation device;
a processor programmable to correlate the positional information with the itinerary data and detect an inability to satisfy the time constraint;
wherein the memory further includes an alternative destination; and
wherein the processor is further programmable to determine whether the alternative destination will satisfy the time constraint and, if so, revise the itinerary by replacing the destination with the alternative destination.

2. The navigation device according to claim 1, wherein the alternative destination is one of a plurality of alternative destinations, and wherein the processor is programmable to determine whether any of the plurality of alternative destinations will satisfy the time constraint.

3. The navigation device according to claim 2, wherein, if multiple alternative destinations are found that will satisfy the time constraint, the processor is further programmable to present a list of alternative destinations to the user and allow the user to select one of the plurality of alternative destinations to replace the destination.

4. The navigation device according to claim 2, wherein, if multiple alternative destinations are found that will satisfy the time constraint, the processor is farther programmable to select one of the plurality of alternative destinations and the thus selected alternative destination is provided to the user as the alternative destination.

5. The navigation device according to claim 3, wherein the selecting by the processor of one of the plurality of alternative destinations includes determining whether any of the plurality of alternative destinations is a same franchise as the destination.

6. The navigation device according to claim 3, wherein the selecting by the processor of one of the plurality of alternative destinations includes determining whether any of the plurality of alternative destinations is a same type of facility as the destination.

7. The navigation device according to claim 3, wherein the selecting by the processor of one of the plurality of alternative destinations includes determining whether any of the plurality of alternative destinations offers a same type of service as the destination.

8. The navigation device according to claim 3, wherein the selecting by the processor of one of the plurality of alternative destinations includes determining whether any of the plurality of alternative destinations is a sponsor destination.

9. The navigation device according to claim 3, wherein the selecting by the processor of one of the plurality of alternative destinations includes determining whether any of the plurality of alternative destinations is on a favorites list prepared by the user.

10. The navigation device according to claim 1, wherein the position detection system includes a global position satellite receiver.

11. The navigation device according to claim 1, wherein the time constraint associated with the destination is one of an earliest time to arrive at the destination, a latest time to arrive at the destination, and a range of times to arrive at the destination.

12. A computer-implemented method of preparing and maintaining an itinerary in a navigation device, the method comprising:
storing in a memory itinerary data associated with the itinerary, the itinerary data including data representative of a destination and a time constraint associated with the destination;
displaying the itinerary;
detecting positional information associated with the navigation device;
correlating the positional information with the itinerary data and detecting an inability to satisfy the time constraint;
wherein the storing further includes storing an alternative destination; and
further comprising determining whether the alternative destination will satisfy the time constraint and, if so, revising the itinerary by replacing the destination with the alternative destination.

13. The method according to claim 12, wherein the alternative destination is one of a plurality of alternative destinations, and the determining includes determining whether any of the plurality of alternative destinations will satisfy the time constraint.

14. The method according to claim 13, wherein, if multiple alternative destinations are found that will satisfy the time constraint, presenting a list of alternative destinations to the user and allowing the user to select one of the plurality of alternative destinations to replace the destination.

15. The method according to claim 13, wherein, if multiple alternative destinations are found that will satisfy the time constraint, selecting one of the plurality of alternative destinations and providing the thus selected alternative destination to the user as the alternative destination.

16. The method according to claim 15, wherein the selecting of one of the plurality of alternative destinations includes determining whether any of the plurality of alternative destinations is a same franchise as the destination.

17. The method according to claim 15, wherein the selecting of one of the plurality of alternative destinations includes determining whether any of the plurality of alternative destinations is a same type of facility as the destination.

18. The method according to claim 15, wherein the selecting of one of the plurality of alternative destinations includes determining whether any of the plurality of alternative destinations offers a same type of service as the destination.

19. The method according to claim 15, wherein the selecting of one of the plurality of alternative destinations includes determining whether any of the plurality of alternative destinations is a sponsor destination.

20. The method according to claim 15, wherein the selecting of one of the plurality of alternative destinations includes determining whether any of the plurality of alternative destinations is on a favorites list prepared by the user.

21. The method according to claim 12, further comprising searching a remote database for an alternative destination that satisfies the time constraint.

22. The method according to claim 12, wherein the time constraint associated with the destination is one of an earliest time to arrive at the destination, a latest time to arrive at the destination, and a range of times to arrive at the destination.
